(19) United States
(12) Patent Application Publication
(10) Pub. No.: US 2016/0012417 A1
(43) Pub. Date: Jan. 14, 2016

(54) SYSTEM AND METHOD FOR LOADING AND RELOADING PREPAID PAYMENT CARDS FROM MOBILE DEVICES

(71) Applicant: MasterCard International Incorporated, Purchase, NY (US)

(72) Inventor: Amy Mizon, Stamford (GB)

(21) Appl. No.: 14/797,111

(22) Filed: Jul. 11, 2015

(30) Foreign Application Priority Data
Jul. 14, 2014 (GB) 1412492.9

(51) Int. Cl. G06Q 20/34; G06Q 20/32; G06Q 20/40; G06Q 20/28

(52) U.S. Cl. CPC G06Q 20/349; G06Q 20/28; G06Q 20/322; G06Q 20/40

(57) ABSTRACT

Methods and systems for loading and reloading prepaid cards are disclosed. A service layer of a payment facilitator receives a pay-and-load request to load a prepaid card with a desired amount from a mobile application installed at a mobile device. The pay-and-load request comprises payment details. The service layer retrieves a quote stored at the service layer that corresponds to the pay-and-load request. It then transmits, to a payment gateway, a payment authorisation request, which comprises the payment details and a payment amount indicated by the retrieved quote. In response, the service layer receives from the payment gateway an authorisation response. If the authorisation response indicates a successful authorisation, the service layer transmits a load request to load the prepaid card with the desired amount to a payment processing platform.

### CROSS REFERENCE TO RELATED APPLICATIONS

This application claims foreign priority to United Kingdom Patent Application 1412492.9, filed 14 Jul. 2014, the complete disclosure of which is expressly incorporated herein by reference in its entirety for all purposes.

### FIELD OF THE INVENTION

This invention relates generally to stored value cards used for purchasing goods and services and withdrawing cash. In particular, but not exclusively, the invention relates to methods and systems for loading and reloading funds to a prepaid payment card from a mobile device.

### BACKGROUND OF THE INVENTION

Electronic payments are now the primary means for conducting payment transactions around the world. Stored value cards, such as for example prepaid cards, are an example of payment devices used to conduct such transactions.

A prepaid card is a payment card (or a device) that is loaded (or credited) with funds to be used to make purchases. The amount of available funds is then reduced with each purchase made using the card. Prepaid cards often look like a regular credit or debit card, with a card number, a signature strip, and a payment branding (e.g., MasterCard®). However, they are different from credit and debit cards. More specifically, unlike credit cards, prepaid cards do not provide a line of credit.

Furthermore, unlike debit cards, they are not linked to a bank account associated directly with the cardholder (e.g., a checking account). In other words, the amount of funds that can be spent using the prepaid card is limited by the amount of funds that has been pre-loaded onto the prepaid card.

All prepaid cards generally share the same benefit of being safer and more convenient to use than cash. Further, unlike cash, prepaid cards can be used in card-not-present transactions, such as e-commerce transactions. Prepaid cards are also easier and faster to acquire than credit/debit cards and enable their users to control the amount of money they can spend. As such, it is not surprising that the prepaid card market has been growing in recent years and issuers of prepaid cards have been striving to improve and enhance user experiences in that market, for example, by improving existing features and developing new features in association with the prepaid cards.

Usually, issuers of prepaid cards develop independently specific features of their respective prepaid card programs, e.g., terms of use, fees associated with the use, certain benefits, and the like. Two general types of prepaid cards are now commonly in use: a specific purpose (closed-loop) payment card and a general purpose (open-loop) payment card. The specific purpose payment cards are typically issued in affiliation with a particular merchant and can only be used to pay for goods or services of that merchant (e.g., a restaurant gift card). In contrast, the general purpose payment cards are usually issued in the name of a particular customer in affiliation with a particular payment network system (provider), such as MasterCard®, Visa®, American Express®, etc., and are accepted at any merchant location that accepts cards affiliated with that payment network provider. The general purpose prepaid cards also can be used to withdraw cash, for example using an ATM. Unlike the specific purpose prepaid cards, which are often non-reloadable (once the initially-loaded balance is depleted, the prepaid card can no longer be used), the general purpose prepaid cards are usually reloadable. That is, the user of such a prepaid card can top-up the card's balance after the initially-loaded funds have been used, or simply increase the current card's balance.

There are a number ways for users of prepaid cards to top-up (load or reload) their prepaid cards. Prepaid cards may be reloaded using SMS-messages, online via a website, or at a bank. Additionally, an auto-reload from another account may be set-up. The user may also transfer funds directly from his or her bank account to the prepaid card or top-up the prepaid card with cash at participating locations, such as a post office or a convenience store. Furthermore, the user may use his or her credit or debit card to top-up the pre-paid card using a telephone or at a designated website. This latter option typically requires the user to register with (set up an account) the website and register the payment method (e.g., a bank account, a credit card) before being allowed to reload the prepaid card.

One of the features that have become available to users of prepaid cards in recent years is proprietary mobile applications that enable such users to view their prepaid cards' balances and transaction histories on their mobile devices. However, such mobile applications do not allow their users to top-up the prepaid cards using a credit or debit card. Security concerns associated with the processing and storing of financial data on mobile devices and the standards applicable to processing of credit/debit card transactions established in the industry and by the respective payment network providers so far have prevented the development of a feature that would enable a user to use his or her mobile device to top-up the prepaid card and have the respective funds available on the prepaid card almost instantaneously.

Accordingly, although a user may use currently available tools to determine whether he or she has sufficient funds on the prepaid card to make a particular purchase, such a user may not be able to make the purchase if the prepaid card does not have sufficient funds. That is, if the user determines that he or she does not have sufficient funds on the prepaid card while making the purchase, the user may have to use a different type of payment or abandon the purchase because no convenient, immediate, and secure tool for reloading the prepaid card is available to the user.

There is therefore a need to provide users in such situations with means to top-up the prepaid card in a fast and secure manner so as to enable the user to make the purchase using the prepaid card. More generally, there is a need to provide a method and/or a system for loading and reloading prepaid cards from a mobile device using a credit or debit card, without comprising the security of the respective financial data. There is a further need to provide a method and/or a system for loading and reloading prepaid cards using a credit or debit card without requiring the user to register such a card.

### SUMMARY OF THE INVENTION

The described embodiments of the invention provide for methods and systems for loading and reloading prepaid cards from mobile devices.

In one embodiment, the present disclosure provides a method for loading a prepaid card, the method executed at a service layer of a payment facilitator, the method comprising: receiving, from a mobile application installed at a mobile device, a pay-and-load request to load the prepaid card with a desired amount, the pay-and-load request comprising payment details; retrieving a quote stored at the service layer, the quote corresponding to the pay-and-load request; transmitting, to a payment gateway, a payment authorisation request comprising the payment details and a payment amount indicated by the retrieved quote; receiving an authorisation response from the payment gateway responsive to the payment authorisation request; and transmitting, to a payment processing platform, a load request to load the prepaid card with the desired amount, if the authorisation response indicates a successful authorisation.

In some example embodiments, the method for loading a prepaid card further comprises: receiving a load response from the payment processing platform responsive to the load request; and transmitting, to the mobile application, a message indicating that the prepaid card was successfully loaded if the load response indicates the same.

In some example embodiments, the method for loading a prepaid card further comprises: validating the quote prior to transmitting the payment authorisation request to the payment gateway.

In some example embodiments, validating the quote comprises at least one of: confirming that the quote has not expired or confirming that the desired amount does not exceed a pre-set amount limit.

In some example embodiments, the method for loading a prepaid card further comprises: transmitting an error message to the mobile application in response to the pay-and-load request if validating the quote fails.

In some example embodiments, the method for loading a prepaid card further comprises: validating the payment details prior to transmitting the payment authorisation request to the payment gateway.

In some example embodiments, the method for loading a prepaid card further comprises: transmitting an error message to the mobile application in response to the pay-and-load request if validating the payment details fails.

In some example embodiments, the method for loading a prepaid card further comprises: transmitting an error message to the mobile application in response to the pay-and-load request if the authorisation response indicates that the payment amount was not authorised or the load response indicates that the prepaid card was not successfully loaded.

In some example embodiments, the method for loading a prepaid card further comprises: receiving, from the mobile application, a request for the quote to load the prepaid card with the desired amount; generating the quote comprising one or more fees associated with loading the prepaid card with the desired amount; and storing the quote in a database of the service layer.

In some example embodiments, the method for loading a prepaid card further comprises: transmitting the quote to the mobile application.

In some example embodiments, generating the quote comprises: transmitting a fee request to a reference data service platform in association with the received quote, wherein the reference data service platform maintains one or more fee schedules; receiving, from the reference data service platform, in response to the fee request, the one or more fees; and calculating the quote.

In some example embodiments, the one or more fees associated with loading the prepaid card with the desired amount comprise at least one of: a service fee, a transaction fee, a commission fee associated with currency conversion, or an exchange rate.

In some example embodiments, the one or more fees associated with loading the prepaid card depend on at least one of a customer type associated with the prepaid card, a type of the prepaid card, or a customer service agreement.

In some example embodiments, the prepaid card is a multicurrency card supporting a plurality of currencies and the desired amount is in a desired currency of the plurality of currencies.

In some example embodiments, determining the payment amount comprises: calculating an amount in a payment currency using the desired amount and a current exchange rate between the desired currency and the payment currency; and determining the payment amount using at least the calculated amount, wherein the payment details identify an account in the payment currency.

In some example embodiments, the service layer maintains current exchange rates for a plurality of currencies.

In some example embodiments, the prepaid card is a multicurrency card supporting a plurality of currencies and the desired amount is in a desired currency of the plurality of currencies.

In some example embodiments, generating the quote comprises: calculating an amount in a payment currency using the desired amount and a current exchange rate between the desired currency and the payment currency; providing the calculated amount to the mobile application; receiving a request for fees associated with loading the prepaid card with the desired amount; requesting, from a reference data service platform, current fee and commission information; calculating, based on the received current fee and commission information, fees associated with loading of the prepaid card with the desired amount; and generating the quote based on the calculated amount and the calculated fees.

In some example embodiments, the payment facilitator maintains the reference data service platform.

In some example embodiments, the payment details are received via a secure connection.

In some example embodiments, the payment details are received via a communication channel established under a secure socket layer (SSL) protocol.

In some example embodiments, the payment details identify one of a credit card and a debit card that is not registered with the mobile application.

In some example embodiments, the payment details comprise at least a payment card number, an expiry date, and a cardholder verification code printed on the back of a payment card (CVC2).

In some example embodiments, any of the methods described above is computer-implemented.

In some example embodiments, a system is provided, the system comprising one or more processors, and memory comprising instructions which when executed by the one or more processors causes the system to carry out any of the methods described above.

In some example embodiments, a non-transitory computer-readable medium is provided, the medium storing program instructions for causing a processor to perform any of the methods described above.

In some example embodiments, a system for loading a prepaid card is provided, the system comprising a reference data service platform storing at least current fee and commission information; and a service layer operable to communicate with the reference data service platform and further operable to communicate, via a secure communication channel, with a mobile application for loading a prepaid card, installed at a mobile device, the service layer comprising: a memory that stores quotes for loading prepaid cards generated by the service layer and at least one processor configured to perform any of the methods described above.

In another embodiment, the present disclosure provides a method for loading a prepaid card via a mobile application installed at a mobile device, the method comprising: receiving, via a user interface of the mobile application, a request from a user to load the prepaid card with a desired amount; requesting, from a service layer of a payment facilitator, a quote for loading the prepaid card with the desired amount; receiving the quote from the service layer; and, when a user acceptance of the quote displayed by the mobile application is received via the user interface, prompting the user to enter payment details; capturing the payment details; and transmitting a request to load the prepaid card including the captured payment details toward the service layer of the payment facilitator via a secure communication channel.

In some example embodiments, the method for loading a prepaid card further comprises: enabling the user to enter a request to load the prepaid card with a second desired amount.

In some example embodiments, the method for loading a prepaid card further comprises: receiving from the service layer a response to the request to load.

In some example embodiments, the method for loading a prepaid card further comprises: confirming to the user via the user interface that the prepaid card has been successfully loaded if the received response indicates the same; and informing the user about an error associated with loading the prepaid card, if the received response indicates that the card has not been loaded with the desired amount.

In some example embodiments, the mobile device becomes out of service after transmitting the request to load the prepaid card toward to the service layer; and the prepaid card is loaded with the desired amount responsive to the request while the mobile device is out of service.

In some example embodiments, the prepaid card is a multicurrency card supporting a plurality of currencies and the desired amount is in a desired currency of the plurality of currencies.

In some example embodiments, requesting the quote for loading the prepaid card comprises: requesting the service layer to provide an amount in a payment currency corresponding to the desired amount in the desired currency; receiving the amount in the payment currency; and requesting the service layer to provide fees associated with loading the prepaid card; and wherein the received quote comprises at least the fees and the amount in the payment currency.

In some example embodiments, the received quote is based on at least one of a type of the user and a type of the prepaid card.

In some example embodiments, no payment details are stored by the mobile application.

In some example embodiments, the payment details comprise at least a payment card number, and expiry date, and a cardholder verification value code printed on the back of a payment card (CVC2).

In some example embodiments, the payment details are of a debit card of the user or a credit card of the user.

In some example embodiments, the mobile application is configured to enable the user to perform at least one of: determining a current balance of the prepaid card in one or more currencies associated with the prepaid card; converting funds available on the prepaid card in one currency into funds in a different currency; or deactivating the prepaid card.

In some example embodiments, no fees, exchange rates, or commission fees are stored at the mobile device in association with the mobile application without a reference to a corresponding quote for loading the prepaid card.

In some example embodiments, the secure communication channel is established under a secure socket layer (SSL) protocol.

In some example embodiments, any of the methods described above is computer-implemented.

In some example embodiments, a system is provided, the system comprising one or more processors, and memory comprising instructions which when executed by the one or more processors causes the system to carry out any of the methods described above.

In some example embodiments, a non-transitory computer-readable medium is provided, the medium storing program instructions for causing a processor to perform any of the methods described above.

In some examples, a mobile device is provided, the mobile device comprising: at least one processor; and memory storing instructions, which when executed by the at least one processor cause the mobile device to perform any of the methods described above.

In some examples, a mobile device further comprises a secure connection interface for establishing the secure communication channel between the mobile device and the service layer of the payment facilitator.

### BRIEF DESCRIPTION OF THE DRAWINGS

Embodiments of the present invention will be described, by way of example only, with reference to the accompanying drawings, in which:

FIG. 1 is a block diagram of an example system for (re)loading a prepaid card via the Internet;

FIG. 2 is a block diagram of an example system for (re)loading a prepaid card using a mobile device, according to some embodiments of the present invention;

FIGS. 3 and 4 illustrate flow diagrams of a method for (re)loading a prepaid card using a mobile device, executed server-side, according to some embodiments of the present invention;

FIG. 5 illustrates a flow diagram of a method for (re)loading a prepaid card using a mobile device, executed client-side, according to some embodiments of the present invention;

FIG. 6 shows a block diagram of a mobile device suitable to host a mobile application for (re)loading a prepaid card, according to some embodiments of the present invention;

FIG. 7 depicts a block diagram of a computer system, according to some embodiments of the present invention; and

FIGS. 8 and 9 show examples of a user interface for a mobile application for (re)loading a prepaid card, according to some embodiments of the present invention.

### DETAILED DESCRIPTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents. In the following description, numerous specific details are set forth in order to provide a thorough understanding of the various embodiments. However, the present invention may be practiced without some or all of these specific details. In other instances, well known process operations have not been described in detail in order to not unnecessarily obscure the present invention. Further, each appearance of the phrase “example embodiment(s)” or “illustrative embodiment(s)” at various places in the specification does not necessarily refer to the same example(s) or illustrative embodiment(s).

A number of terms are used herein. The use of such terms is not intended to be limiting, but rather is for convenience and ease of explanation. For example, as used herein, the terms “payment card” and “payment device” generally refer to a credit card, a debit card, or a prepaid card, such as a traditional plastic or embossed magnetic stripe card, a chip card (such as an EMV card), or an RFID card (such as a PayPass card), a virtual card, a mobile device (such as a mobile telephone) operating a payment application on which payment account information or any other card/device suitable to be used for payment is stored, or the like.

Also, as described herein, the term “payment detail(s)” mainly refers to a primary account number (PAN) (generally a number code, typically of 13 to 19 digits, that identifies the issuer of the respective payment device and the payment account and includes a check digit as an authentication device), also referred to as a payment card number, a cardholder verification value (code) printed on the back of a card (CVC2), an expiry date associated with the payment device, an issue date, and issue number, and/or a combination of the above, but may also refer to a customer's name, telephone (e.g., mobile, home, business, etc.), address, and/or the like. Further the terms “consumer,” “user,” “cardholder,” “customer,” and “account holder” are interchangeable in the context of the present disclosure and are used herein to refer to a consumer, individual, business or other entity that has been issued (or authorized to use) a financial account such as a credit, debit, and/or prepaid account.

Illustrative embodiments described herein relate to loading and reloading of prepaid cards and references are made to “pay-and-load” transactions. It should be understood that both loading of the prepaid card with funds for the first time and any subsequent reloading of the prepaid card with additional funds could be referred to as loading of the prepaid card. Similarly, it should be understood that both “pay-and-load” transactions and “pay-and-reload” transactions could be referred to as a “pay-and-load” transaction.

Some illustrative embodiments are described herein with reference to a multicurrency prepaid card. The multicurrency prepaid card is a card that simultaneously supports a plurality of different currencies (e.g., GBP, USD, EUR, CAN, etc.). Multicurrency prepaid cards are typically used by users who travel to different countries (e.g., UK, USA, France, Canada, etc.) so as to pay for goods and services in local currencies. The user of the multicurrency prepaid card is able to load the prepaid card with money in each of the currencies supported by the prepaid card. For example, the user expecting to travel to UK and USA may load £1,000.00 and $1,000.00 on the multicurrency prepaid card at the same time. Then, if the user were to use the prepaid card to make a purchase in the UK, the respective purchase amount would be deducted from the GBP account of the prepaid card, while if the user were to use the prepaid card to make a purchase in the USA, the respective purchase amount would typically be deducted from the US account of the prepaid card.

Although a multicurrency card is a particularly preferred application of the disclosed embodiments, the embodiments are in no way restricted to this application. In particular, the context of the multicurrency prepaid cards is illustrative and the described embodiments and the described techniques are more generally applicable to any general-purpose reloadable prepaid cards, with any level of complexity. Therefore, embodiments according to the invention are not limited by the specific embodiments depicted in the figures and described herein and, rather, are limited only by the scope of the claims that follow.

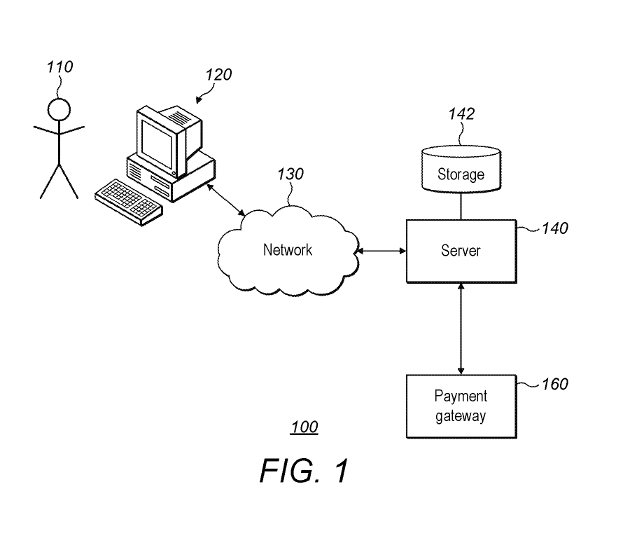

FIG. 1 shows an example system 100 employed for (re)loading a prepaid card via the Internet. The system 100 includes a computer system 120, a network 130, a server 140, and a payment gateway 160. An issuer of the prepaid card or some other entity supporting the prepaid card account and associated services hosts the server 140, which maintains and operates a website for providing some or all of such services. A user 110 having a prepaid card (not shown) is able to access the website and its services using an Internet browser on the computer system 120 via the network 130 to which the computer system 120 is coupled. The server 140 is also in direct communication with the payment gateway 160 that processes payment transactions.

To be able to load (reload) money (funds) on to the prepaid card, the user 110 needs to first register with the website operated by the server 140. The user 110 is also required to register any payment method(s) that the user intends to use to (re)load the prepaid card. For example, the user 110 may register his or her bank account and/or a payment card, such as a debit or credit card. To register a payment method, the server requests the user to enter payment details, which it captures and includes in an authorisation request that the server 140 transmits to the payment gateway 160, so as to authenticate the user's payment method (e.g., a credit card). When the server 140 receives a successful authorisation response from the payment gateway 160, the server 140 registers the user's payment card and stores the payment details in its storage 142, e.g., a database. Then, when the user 110 wishes to (re)load the prepaid card using the registered payment card, the server 140 submits another authorisation request to the payment gateway 160. Such a request includes the payment amount for (re)loading the payment card along with the stored payment details. Upon successful authorisation by the payment gateway 160, the server 140 (re)loads the payment card and updates the prepaid card balance.

Typically, to (re)load the prepaid card, the user is required to pay certain fees, such as transaction fees, commission fees, and/or the like. Some of these fees originate from and are collected by the issuer of the prepaid card. In the system 100, the server 140 maintains such fees in the storage 142 and uses them to calculate the actual payment amount to be deducted when the user requests the prepaid card to be (re)loaded with a certain amount.

Although the system 100 enables the user 110 to reload the prepaid card, this system does not generally allow the user to (re)load the prepaid card on the go. Further, even if the payment has been processed, the corresponding funds may not become available on the prepaid card for a few days. Also, the system, in which the server (1) stores data concerning the prepaid card account and concerning payment methods and (2) hosts the service enabling the user to top-up the prepaid card, while also being in direct communication with the payment gateway, is not transferable to a mobile device environment. In particular, implementing the same scheme at the mobile device may compromise security of financial data and violate the rules applicable to the processing of payment transactions.

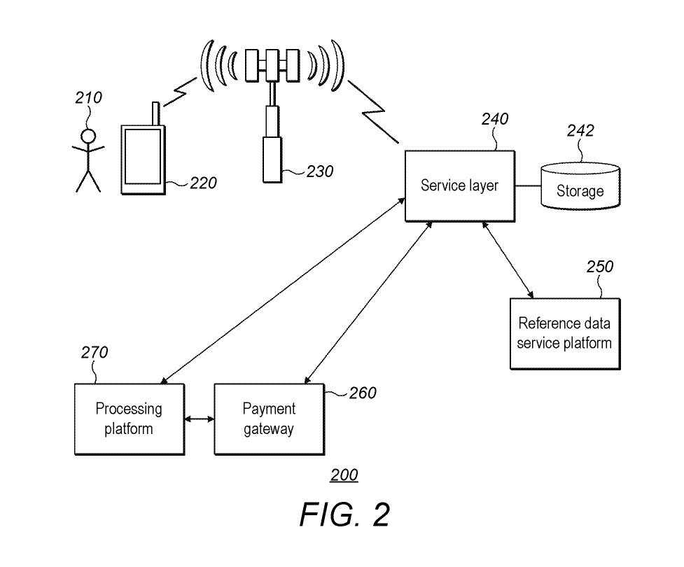

FIG. 2 shows a general overview of a system 200 for (re)loading a prepaid card using a mobile device according to some embodiments. The system 200 includes a mobile device 220 operated by a user 210, a cell network 230, a service layer 240, a reference data service platform 250, a payment gateway 260 (e.g., MasterCard® Datacash Payment Gateway), and a processing platform 270 (e.g., MasterCard® IPS platform). In some example embodiments, the service layer 240, the reference data service platform 250, the payment gateway 260, and the processing platform 270 are all operated under the umbrella of a payment network provider. In some other embodiments, the service layer 240 and the reference data service platform 250 are operated under the umbrella of a payment facilitator or vendor in cooperation with the payment network provider operating the processing platform 270 and/or the payment gateway 260. Generally speaking, the mobile device 210 and the mobile application running on the mobile device form a client side of the system 200. The service layer 240 and the reference data service platform 250, along with the payment gateway 260 and the processing platform 270, form a server side of the system 200.

The mobile device 220 is configured with the Android, iOS, or another operating system and is capable of cellular and/or wireless communication (e.g., via GPRS, 3G or other protocols). The mobile device 220 has a mobile application for managing a prepaid card installed thereon. The mobile application enables the user 210 of the mobile device 220 to load/reload (top-up) the prepaid card using a payment card, such as a credit or debit card. In some example embodiments, the mobile application also provides other services, including but not limited to enabling the user 210 to view balance(s) and/or past transactions, move funds between different supported currencies, locate the closest ATM, and/or activate/deactivate the prepaid card.

The mobile application is generally configured to communicate with the service layer 240 via the cellular network 230 and/or via a Wi-Fi network (not shown) so as to submit a request to (re)load the prepaid card to the service layer 240 and provide required data, such as payment details. In particular, to (re)load (top-up) the prepaid card with a desired amount, the mobile application establishes a secure connection with the service layer 240, for example, communication channel under a secure socket layer (SSL) protocol, via the network 230, and requests the service layer 240 to provide a quote for (re)loading the prepaid card with the desired amount. When the user accepts the quote provided by the service layer 240, the mobile application requests the user 210 to enter payment details for funding the transaction and provides such payment details, via the same secure connection, to the service layer 240 for processing. In some example embodiments, only security sensitive data, such as payment details, are transmitted between the mobile application and the service layer 240 via the secure connection.

Thus, in the system 200, the mobile device 210, along with the mobile application installed thereon, does not process transactions of loading or reloading the prepaid card (pay-and-load transactions), but merely facilitates such transactions. In particular, the mobile device accepts a user's request to (re)load the prepaid card, captures payment details of an account for funding the pay-and-load transaction, and securely provides such payment details to the service layer 240. The main functions of the system 200 however are centred at the server side of the system 200, and in particular at the service layer 240, which controls, operates, and manages pay-and-load transactions and associated services initiated/requested by the mobile device 220. It should be understood that the service layer 240 may control, operate, process, and/or manage such transactions for a multitude of mobile devices and/or prepaid card customers simultaneously.

To control, operate, and manage the pay-and-load transactions initiated via the mobile application, the service layer 240 employs storage 242 at which it stores the pay-and-load transaction data such as previously provided quotes, as well as data concerning successful transactions. The service layer 240 also employs the reference data service platform 250, which generally serves as a central depository and a source of data that the service layer 240 may require for processing a pay-and-load transaction. For example, in some example embodiments, the reference data service platform 250 stores transaction fees, service fees, and commission fees, which it provides to the service layer 240 upon receiving a respective request.

Further, in some example embodiments, the reference data service platform 250 also stores current exchange rates. Yet, in some other example embodiments, the service layer 240 stores the exchange rates instead. Further, in yet some other example embodiments, the service layer 240 obtains such exchange rates from an independent third-party entity. In other words, the system 200 stores data relevant to processing of pay-and-load transactions server-side and is updated on the as-needed basis. Such data may change over time and may differ for different customers, types of customers, prepaid cards, types of prepaid cards, and the like. However, since the data is stored server-side, no updates to the mobile application reflective of the changes are required. Rather, all updates are performed server-side. Accordingly, no burden is placed on the user 210 of the mobile device 220 to keep the mobile application updated and the user 210 is always provided with a quote for (re)loading the prepaid card based on the current data, even if the user 210 has not updated the mobile application for a while.

The processing platform 270 is generally an infrastructure with integrated software. It processes prepaid, as well as signature- and PIN-based transactions, performs card management, back office processing services, and/or provides the like services. In the context of the example embodiments described herein, the processing platform 270 provides support to the lifecycle of a prepaid account, including but not necessarily limited to loading and reloading of the prepaid card, account and prepaid card management, prepaid account closing and opening, and/or the like. The payment gateway 260 processes payment transactions for funding the pay-and-load transactions and is in communication with the processing platform 270 when needed.

The centralised, server-based arrangement of the system 200 provides a number of advantages. As already discussed above, when certain fees and/or terms of service change, the mobile application installed at the mobile device 220 does not require an update. Thus, not only is there no burden on the user, but also the unreliability component that is otherwise created by the user's participation in the process is removed from the system. In particular, unlike the mobile application updates, which require user's active participation, the payment facilitator has full control over how and when to update the reference data service platform and/or service layer, and thus is able to ensure that all relevant data is current and quotes provided to the mobile applications are accurate and up to date.

Furthermore, since the main processing of the pay-and-load transactions is performed at the server side, with the mobile application merely submitting a request and providing payment details, the prepaid card can be successfully (re)loaded after such information has been received, even if the mobile device 220 lost connection (e.g., due to leaving the service area) before the prepaid card has been (re)loaded. Additionally, the potential negative effects of user's current location (positioning) and quality of signal on the processing of the pay-and-load transactions are substantially removed, enabling the payment facilitator to process the pay-and-load transactions reliably and to address any faults efficiently and without involving the user 210 or the mobile device 220 in most of the scenarios.

Moreover, the server-sided arrangement of the system 200 allows flexibility and simplicity in relation to the mobile application. As the complex fee schedules, fees, and other relevant data are not maintained by the mobile application, but instead are maintained server-side, the same version of the mobile application may be deployed to all customers of the payment facilitator, regardless of their type, the prepaid card types, terms of service, and the like. All customisation is performed at the server side instead. In this manner, the mobile device does not require as much memory space or processor time or power to run the mobile application. Thus, the arrangement of the system 200 conserves the mobile device resources, increases the speed with which the mobile application is able to operate, and improves reliability of the mobile application.

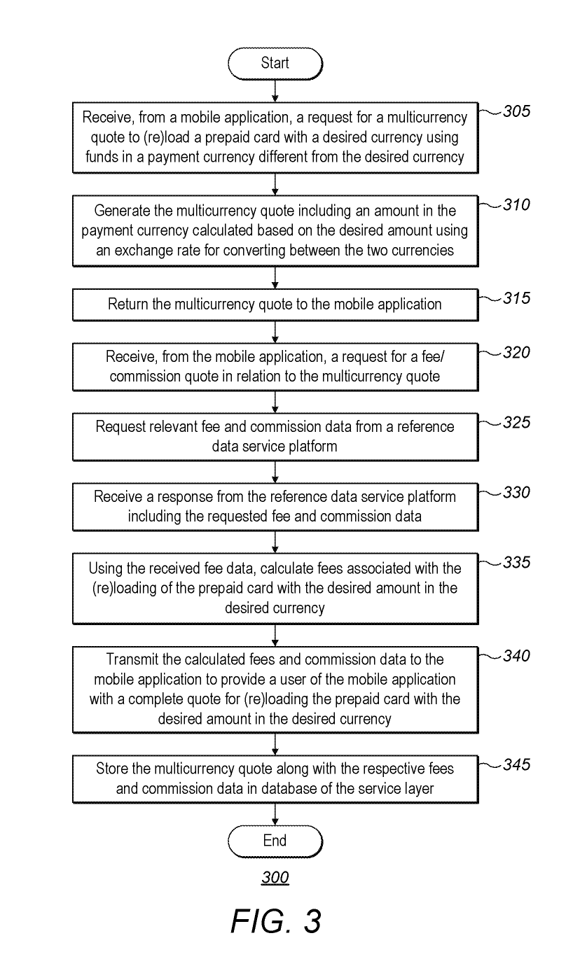

Some further details concerning functions of and operations performed by the components of the system 200 are described below with respect to FIGS. 3 to 5.

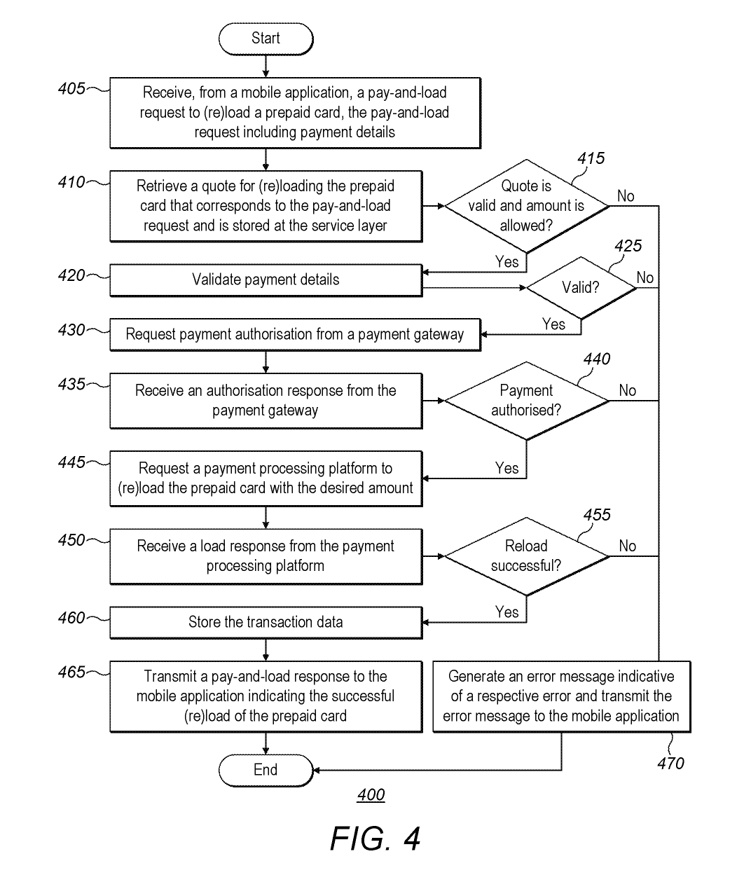

FIGS. 3 and 4 depict a method for (re)loading a prepaid card using a mobile device, according to some embodiments. FIG. 3 depicts a flow diagram of a process 300 for generating a quote for (re)loading the prepaid card with a desired amount. FIG. 4 depicts a flow diagram of a process 400 for (re)loading the prepaid card with a desired amount based on the quote, once it was accepted by a user of the mobile device. Both processes are executed server-side, such as by a service layer of a payment facilitator described above with respect to FIG. 2, or a similar entity.

The process 300 of FIG. 3 is described using an example of a multicurrency prepaid card. However, the process 300 is not limited to the multicurrency prepaid cards and may, as discussed in greater detail below, be adapted to generate and provide a quote in relation to any general purpose prepaid card.

The process 300 starts with step 305 at which the service layer receives a request for a multicurrency quote from a mobile application. Generally, such a quote is generated by the mobile application of the mobile device responsive to user's input via a user interface of the mobile application. FIG. 800 shows an example of such an interface, according to some illustrative embodiments.

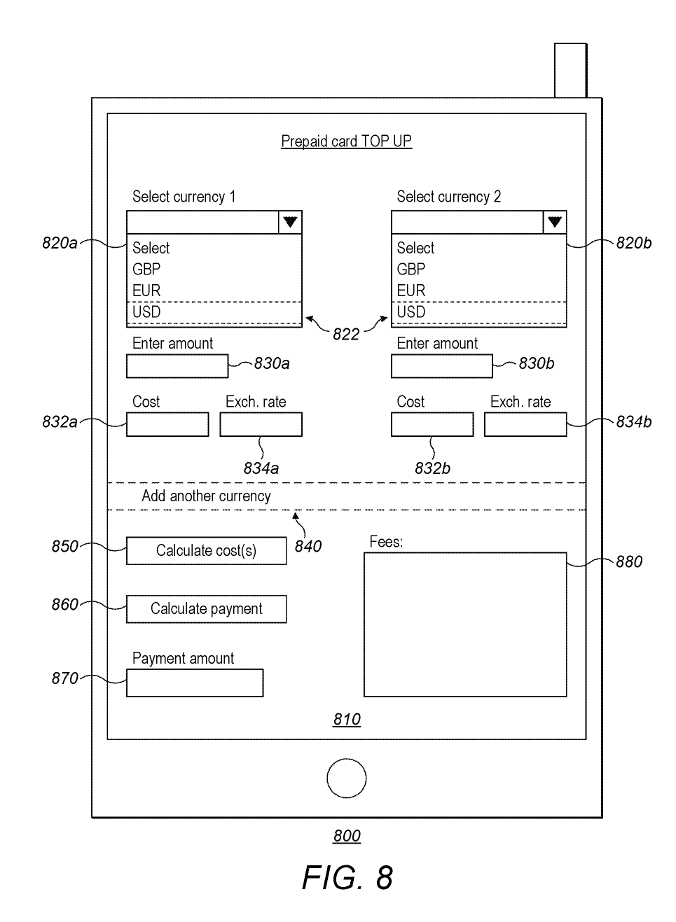

For example, the user may wish to (re)load the prepaid card with a certain amount in a desired currency (one of the currencies supported by the prepaid card) using a different currency to pay for the transaction. As shown in FIG. 8, the user may select one of the supported currencies using a drop-down menu 820 and enter a desired amount in the respective field 830a.

The payment currency however is typically a default currency, such as a currency of the country where the prepaid card account was open, and as such does not necessarily need to be selected. For example, for a prepaid card opened in the UK, the default currency may be GBP. However, in some embodiments, the user is allowed to select the payment currency as well, when requesting the multicurrency quote, for example, by using a drop-down menu, such as a menu 820b. After the user selects the desired currency and/or the payment currency and enters the respective amount, he or she may request for the cost in the payment currency to be calculated, for example, by clicking (pushing, engaging, or otherwise selecting) a button 850. This will cause the mobile application to generate the respective request for the multicurrency quote and transmit the request to the service layer.

As the multicurrency prepaid card supports a plurality of currencies, the user may wish to (re)load funds in more than one currency to the prepaid card. In some example embodiments, the user is allowed to do so only consecutively, first loading the prepaid card with funds in one currency, and then in another currency. In some example embodiments however the mobile application allows the user to select more than one desired currencies and enter respective amounts before the request for the multicurrency quote is generated. For example, the user may select two currencies using the drop-down menus 820a and 820b and, if needed, request the mobile application for additional dropdown boxes by clicking a button 840. Once the user selects all the desired currencies and enters all the respective amounts, the user may click the button 850 so as to cause the mobile application to generate the respective multicurrency quote request. When the user has selected to (re)load the prepaid card in a plurality of currencies using a single transaction, the generated multicurrency quote request includes each such currency along with a corresponding amount.

Returning to FIG. 3, at step 310, the service layer generates the multicurrency quote responsive to the mobile application's request, and then returns the multicurrency quote to the mobile application. Generally, the service layer uses current exchange rate(s) to convert the amount(s) in the desired currency included in the quote into amount(s) in the payment currency. In some example embodiments, the exchange rate(s) are stored at the service layer, e.g., in a database, and may be exchange rates that have been set based on widely accepted exchange rates (such as a Forex rate, a rate set by a particular bank, etc.). In some example embodiments however, the service layer does not store current exchange rates, but rather requests for the relevant exchange rate from an external entity, such as the reference data service platform or some independent third entity. The generated multicurrency quote generally includes the calculated amount(s) in the payment currency that correspond to the amount(s) in the desired currency requested by the mobile application. The quote may further include additional information, such as the exchange rate(s) used to calculate the amount(s) in the payment currency.

At step 315, the service layer returns the generated multicurrency quote to the mobile application. As shown in FIG. 8, the user interface of the mobile application may, for example, display the calculated amounts in the “cost” fields 832a and 832b.

Returning to FIG. 3, at step 320, the service layer receives, from the mobile application, a request for a fee quote in relation to the earlier provided multicurrency quote. Typically, currency conversion operations and/or (re)loading the prepaid card with a desired amount have associated fees and/or commissions that the user is required to pay in order to (re)load the prepaid card. Thus, the actual payment amount for (re)loading the prepaid card with a desired amount is usually higher than the desired amount or its equivalent in the payment currency. In some example embodiments, the user is informed about such fees and/or provided with the total payment amount to enable the user to decide whether to proceed forward with the pay-and-load transaction.

In the example embodiments of FIG. 3, the service layer does not store information concerning fees, commissions, or other fees applicable to the pay-and-load transactions. Rather, the service layer employs services of a reference data service platform (also discussed with respect to FIG. 2) that stores and regularly updates such information. At step 325, the service layer requests such a reference data service platform to provide fee and commission data relevant to the multicurrency quote.

In some example embodiments, different fee/commission/rate structures (schedules, or the like) apply to different consumers and/or prepaid cards, for example, depending on their type and/or service agreements. The request for the relevant fee and commission data thus includes a reference that would enable the reference data service platform to locate and return applicable fee and/or commission structure (schedule) and/or determine relevant fees and/or commission. For example, the type of the prepaid card, the type of the associated service agreement, the prepaid account number and/or the like may be included into the request.

At step 330, the service layer receives a response from the reference data service platform that includes the appropriate fee and/or commission data. Based on data included in the response, as step 335, the service layer calculates fees and/or commission for the multicurrency quote. For the example, the fee and commission data provided by the data reference service platform may be in the form of a rate (or a set of rates for different amount bands) applicable to the pay-and-load transaction. The service layer then calculates the fees and/or the actual payment amount using the received rate(s) in relation to the previously calculated amount in the payment currency. In this manner, the service layer is able to generate a final complete quote for (re)loading the prepaid card with the desired amount(s). If the multicurrency quote includes multiple amounts for multiple currencies, in some embodiments, the final quote would include the total payment amount that required to (re)load the prepaid card with the desired amounts in all the desired currencies.

At step 340, the service layer transmits the final quote, including the calculated fees and/or total payment amount and/or commission fees, to the mobile application. Such a quote may be displayed to the user via the user interface of the mobile application. For example, the user interface of FIG. 8 includes fields 870 and 880 for displaying the total payment amount and/or fees/commissions respectively. At step 340 of the process 300, the service layer stores the quote it provided to the mobile application for future reference and retrieval, for example, if the user accepts the quote.

Although the process 300 is described in relation to multicurrency prepaid cards, it can be adapted to any general purpose reloadable cards. For example, if the prepaid card is a single currency prepaid card, the desired currency and the payment currency are the same and no currency conversion is required. Thus, the steps 305 to 315 are not needed. The steps 320 to 345 however are generally executed in the manner described above.

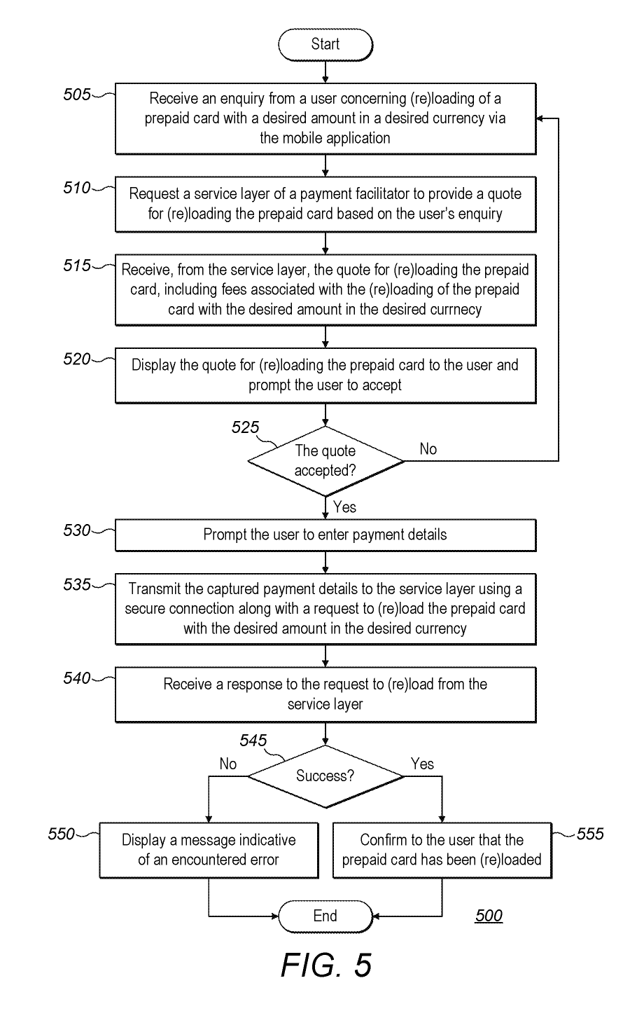

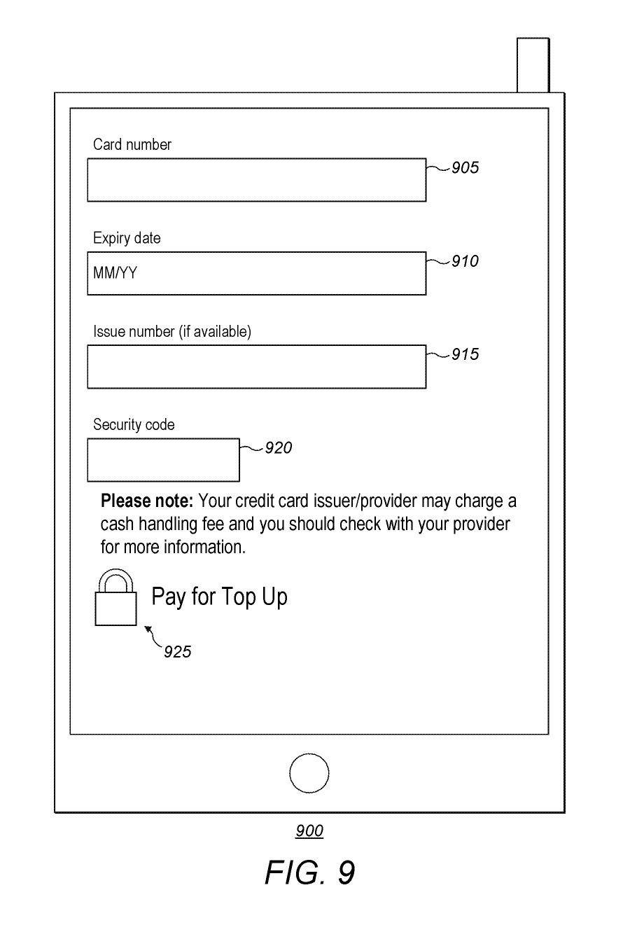

Turning to FIG. 4, the process 400 starts with step 405 at which the service layer receives, from a mobile application, a pay-and-load request to (re)load the prepaid card with a desired amount, along with payment details. In some illustrative embodiments, such a request is submitted in response to the user accepting the final quote previously provided to the mobile application by the service layer and includes a reference to the quote. For example, as shown in FIG. 8, the user interface of the mobile application may include a designated button 890 for accepting the quote. Clicking the button 890 triggers the mobile application to generate the pay-and-load request. As discussed in greater detail with respect to FIG. 5, the mobile application requires the user to enter payment details, for example, via a user interface shown in FIG. 9, and then finalises and transmits the pay-and-load request to the service layer.

Returning to FIG. 4, since the accepted quote is also stored locally at the service layer, the service layer retrieves such a quote at step 410 upon receiving the pay-and-load request, for example, using the reference from the request. At step 415, the service layer confirms that the quote is still valid and the payment amount associated with the quote is allowed.

In some example embodiments, the quote is valid only for a pre-set period after its issuance. The validity period may differ depending on the type of quote, a type of the consumer who has requested the quote, a type of the prepaid card, a service agreement between the consumer and the issuer of the prepaid card, when the quote was generated, and/or the like. For example, if the prepaid card is a multicurrency prepaid card supporting a plurality of currencies and the desired currency and the payment currency differ, the respective quote may have a short validity period due to constantly changing exchange rates. In some example embodiments, instead, or in addition to setting the validity period for quotes generated at the service layer, the service layer checks whether the quote is still valid by comparing the exchange rate (or other fees) used to generate the quote and the current exchange rate (or respective fees). If the desired currency and the payment currency are the same, for example, when the prepaid card is a single currency card, the corresponding quote may have a longer validity period, or alternatively, not expire.

At step 415, the service layer also confirms that the payment amount required to (re)load the prepaid card with the desired amount does not exceed a certain pre-set amount. The pre-set amount may vary for different types of prepaid cards, types of consumers, consumers themselves, countries, currencies, service terms established by the payment network service provider, and/or the like. For example, in some embodiments, the pre-set amount is set to be smaller than an amount that would trigger the 3D secure verification of the payment. In some other embodiments, the pre-set amount is defined by the terms and conditions of the prepaid card being (re)loaded. The pre-set amount may also be adjustable and vary over time. In some example embodiments, the pre-set amount is defined in relation to an amount that the user wishes to load (reload) on the prepaid card, rather than by the payment amount, which is generally larger than the amount that will be loaded at the prepaid card since the payment amount includes associated fees.

If the service layer is not able to successfully confirm that the quote is valid or if the payment amount (or desired amount) exceeds the pre-set amount, the service layer generates an error message, which is then transmitted to the mobile application at step 470. In some embodiments, the error message merely indicates that an error has occurred and the (re)load of funds was unsuccessful. In some other embodiments, the error message provides details concerning the error, for example, indicating that the quote expired and a new quote should be requested or that the payment amount exceeds the allowed amount.

If the service layer successfully confirms that the quote is valid, then at steps 420 and 425, the service layer validates the payment details. The validation performed at step 420 is cursory and does not require the service layer contacting a payment gateway. Rather, it is designed to catch obvious errors with the payment details. For example, the service layer may confirm that the provided payment details conform to one of the known types of the payment details (e.g., a correct number of digits in the card number), the expiry date of the payment device is current or later, the issue date is current or earlier, and the like. If the service layer cannot successfully validate the payment details, a respective error message is generated and then transmitted to the mobile application at step 470. In some embodiments, the error message merely indicates that an error has occurred and the (re)load of funds was unsuccessful. In some other embodiments, the error message provides details concerning the error, for example, that the payment details are incorrect.

If the service layer successfully validates the payment details, then, at step 430, it requests the payment gateway to authorise the payment for the total payment amount, including all associated fees and commissions. The authorisation request that the service layer submits to the payment gateway generally conforms to the rules for processing payment transactions and is similar to other authorisation requests processed by the payment gateway, such as an authorisation request concerning a credit card purchase made in a store. As such, the payment gateway processes the authorisation request received from the service layer in the same manner as any other authorisation request that the payment gateway receives, generating a respective authorisation response. The service layer receives the authorisation response generated by the payment gateway at step 435.

Based on the authorisation response, at step 440, the service layer determines whether the payment transaction for (re)loading the prepaid card was authorised. If the payment transaction was declined, the service layer generates an error message, which it transmits to the mobile application at step 470. In some example embodiments, the error message merely indicates that an error has occurred and the (re)load of funds was unsuccessful. In some other example embodiments, the error message provides details concerning the error, for example, that the payment was declined.

If the authorisation response received from the payment gateway indicates that the payment transaction was authorised, the service layer then generates and transmits a request to a processing platform (such as processing platform 270 discussed with respect to FIG. 2) to load/reload the prepaid card with the desired amount (step 445). At step 450, the service layer receives a response from the processing platform concerning the (re)load request. If the prepaid card was (re)loaded successfully, the service layer stores, at step 460, the corresponding transaction data in its database and, at step 465, generates and transmits a pay-and-load response to the mobile application indicating that the prepaid card was successfully (re)loaded with the desired amount. If however the response received from the payment processing platform indicates an error, a corresponding error message is generated and transmitted to the mobile application. In some example embodiments, such an error message would indicate a business error.

In some illustrative embodiments, responsive to the error message from the processing platform, one or more attempts (e.g., 3 retries) to load the prepaid card with the desired amount are made. If unsuccessful, a respective query concerning the failure to load the prepaid card is automatically generated and transmitted to a support department of the payment facilitator.

FIG. 5 illustrates a flow chart of a method 500 for (re)loading a prepaid card via a mobile application installed at a mobile device. The method 500 starts with step 505 at which the mobile application receives an enquiry from a user who wishes to (re)load the prepaid card with a desired amount in a desired currency. In some embodiments, the enquiry is generated in response to the user responding to respective prompts of a user interface of the mobile application to select and/or enter information. For example, the mobile application may prompt the user to enter the desired amount and select a desired currency and/or a payment currency, e.g., by using a drop-down menu, such as discussed above with respect to FIGS. 3 and 8 and shown in FIG. 8.

In accordance with some embodiments, the mobile application does not generally store data concerning exchange rates, service fees, transaction fees, commission fees, or other associated fees, unless such fees are tied to a particular quote for (re)loading the prepaid card. Rather, such data is stored remotely at the payment facilitator. Accordingly, responsive to the user's enquiry, at step 510, the mobile application requests a service layer of the payment facilitator to provide a quote for (re)loading the prepaid card with the desired amount in the desired currency. At step 515, the mobile application receives the requested quote from the service layer, including fees associated with (re)loading of the prepaid card with the desired amount in the desired currency. The quote is generated in accordance with the principles discussed above with respect to FIG. 3. Such a quote is displayed to the user at step 520 and the mobile application requests the user to accept the quote.

If the user does not accept the quote (step 525), the method returns to step 505 at which a new enquiry may be received from the user. Steps 505 to 525 are repeated until the user is satisfied with the received quote and accepts it.

As discussed in greater detail with respect to FIGS. 3 and 8, for certain types of prepaid cards, such as multicurrency prepaid cards, the quote generation process may involve a series of interactions between the mobile application and the service layer. First, the mobile application requests and receives from the service layer a multicurrency quote for (re)loading the card in a currency different from the payment currency. The multicurrency quote, provided by the service layer, enables the mobile application to provide the user with the cost in the payment currency to (re)load the prepaid card with the desired amount in the desired currency. The user may choose to accept the cost and request the mobile application for a full quote that would include any fees associated with the (re)load, or change the desired amount and/or the desired currency.

When the user is satisfied with the cost and indicates the same to the mobile application, the mobile application is triggered to request the service layer for the fee/commission quote. As discussed in greater detail with respect to FIG. 3, the service layer provides the mobile application with a fee quote or a full quote, which is then displayed to the user. In some example embodiments, the mobile application receives a fee quote from the service layer and then determines the total payment amount based on the cost and the fee quote. In some other example embodiments, the mobile application does not need to calculate the payment amount. Rather, such a payment amount is received by the mobile application as a part of the final quote, which the mobile application then merely displays to the user.

In some example embodiments, the final quote displayed to the user generally includes the total payment amount in the payment currency and the desired amount in the desired currency. Additionally, associated transaction fees, service fees, commission fees, and/or the like may be displayed separately. To facilitate interactions of the user with the mobile application and display of the quotes, the mobile application employs a user interface, such as the user interface shown and discussed in reference to FIG. 8.

Returning to the method 500, if the user accepts the final quote, for example, by selecting a respective button or icon, the mobile application prompts the user to enter payment details of an account for withdrawing the payment amount (at step 535). In some embodiments, the user is requested to enter a payment card number, CVC2, an expiry date, and an issue date (if available) in respective fields, for example, fields 905, 920, 910, and 915 respectively shown in FIG. 9. After entering the payment details, the user confirms that he or she would like to proceed with the pay-and-load transaction, for example, by activating a designated icon, such as an icon 925 of FIG. 9.

The mobile application captures the payment details entered by the user and, at step 540, transmits the captured payment details to the service layer of the payment facilitator for processing. The transmission of the payment details is performed using a secure communication channel established between the mobile application and the service layer, for example, using a designated communication interface to establish an SSL connection.

At step 540, the mobile application receives a response to its request to (re)load the prepaid card with the desired amount in the desired currency from the service layer. If the response indicates that the prepaid card was successfully (re)loaded, the mobile application confirms the same to the user at step 555, for example by displaying a corresponding message and/or updating data concerning the prepaid card's balance in the mobile application. If the response instead indicates that an error has occurred and that the prepaid card has not been (re)loaded, the mobile application then displays an error message and informs the user that he/she was not successful. In some embodiments, the error message displayed to the user is indicative of the occurred error, e.g., identifies incorrect payment details, insufficient funds, a business error or provides some other appropriate explanation.

In accordance with the described methods and techniques, pay-and-load transactions are mainly processed externally to the mobile application and the mobile device at which the mobile application is installed. The mobile application primarily serves as a facilitator for capturing the payment details. As soon as the user approves the quote and enters the payment details, and such details are transmitted from the mobile application toward the service layer, no further input or action from the mobile application is required to successfully (re)load the prepaid card.

For example, the mobile device may leave the service area before the prepaid card is (re)loaded. However, that would not affect the processing of the pay-and-load transaction. Rather, the prepaid card will still be successfully (re)loaded, assuming all necessary payment and quote criteria are satisfied. The user however may not receive a respective notification until the mobile device returns to the service area. That is, although steps 540 to 555 are omitted, the prepaid card is still successfully (re)loaded. In this manner, the integrity and security of the financial data is safeguarded and probability of errors associated with the processing of pay-and-load transactions is reduced. Furthermore, if errors do occur during the processing of pay-and-load transactions, such errors can be fixed with relative ease since the repair process does not require user participation or communication with the user mobile device.

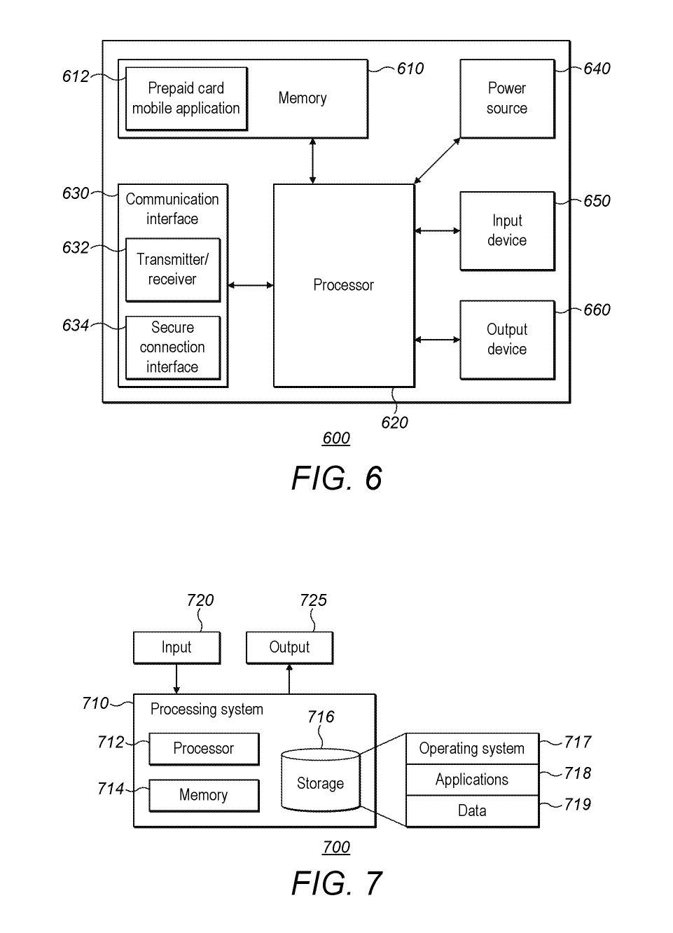

FIG. 6 depicts a mobile device 600 suitable to run a mobile application for (re)loading a prepaid card, according to some embodiments. The mobile device 600 may be any mobile communication device capable of hosting a mobile application and enabling data to be exchanged between the mobile application and a designated entity such as a payment network provider via a secure channel. The mobile device 600 may, for example, be a cellular communication device, such as a mobile phone or a smart phone, or a mobile device with a wireless access, such as a tablet, a laptop or a personal digital assistant, and/or the like.

The mobile device 600 generally includes one or more processors 620 operatively coupled to memory 610, a communication interface 630, a power source 640, input devices 650 (such as a keyboard, a touch screen, a microphone, and/or the like), and output devices 660 (such as a screen, a speaker, and/or the like). The processor 620 includes circuitry that implements communication and logic functions of the mobile device 600, such as a digital signal processor device, a microprocessor device, various analog to digital and/or digital to analog converters, and/or other support circuits for operating the components of the mobile device 600.

The memory 610 includes any computer readable non-transitory medium or the like configured to store data, code, or other information. For example, the memory 610 may include volatile memory, non-volatile memory, magnetic and optical storage devices such as disk drives, magnetic tape, CDs (compact discs), DVDs (digital versatile discs), or other non-transitory media that are capable of storing code and/or data. The memory 610 can be embedded and/or may be removable. The non-volatile memory may additionally, or alternatively, include an electrically erasable programmable read-only memory, flash memory, and/or the like.

The memory 610 is configured to store any of a number of applications or programs for operating the mobile device 600 and/or the mobile device 600. The application and/or programs generally comprise computer-executable instructions/code which, when executed (operated, or the like) by the processor 620, implement the functions of the mobile device 600 described herein. For example as shown, the memory 610 may include a prepaid card mobile application 612. When executed, the prepaid card mobile application 612 performs one or more of the functions described above with respect to FIGS. 5, 8, and 9. The application 612, as well as any other application(s) stored in the memory 610, may provide a graphical user interface (GUI) on a display of the mobile device 600. For example, the GUI for the prepaid mobile card application 612 enables the user of the mobile device 600 to check the balance on the prepaid card, request to (re)load the prepaid card, enter and submit payment card information for (re)loading the prepaid card (as, for example, discussed with respect to FIGS. 8 and 9) and/or the like.

The memory 610 may also store data and other information used by the mobile device 600 and its components to implement the functions of the mobile device 600 and/or the other systems described herein. For example, the memory 610 may include user authentication information for accessing the prepaid card mobile application 612 by the user of the mobile device 600 (e.g., password information, secure key(s), fingerprint data, and the like).

In the illustrative embodiments of FIG. 6, the processor 620 is further configured to enable the prepaid card mobile application 612 to communicate with the vendor of the mobile application 612 and/or payment network provider (and/or other payment facilitator) using the communication interface 630 to perform the functions of the prepaid card mobile application described herein. For example, the prepaid card mobile application 612 provides captured payment details to the payment facilitator via a secure connection, e.g., a connection established in accordance with the SSL protocol by a secure connection interface 634.

The communication interface 630 of FIG. 6 further includes an antenna operatively coupled to a transmitter and receiver 632. The processor 630 is configured to provide signals to and receive signals from the transmitter and receiver 632. These signals include signaling information in accordance with the air interface standard of the applicable cellular system of the wireless telephone network (such as a second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like) and/or in accordance with non-cellular communication mechanisms, such as via a wireless local area network (WLAN) or other communication/data networks.

As described herein, the mobile device 600 includes a user interface that includes input devices 650 for entering data by the user of the mobile device 600, such as in response to prompts of the mobile application, and/or output devices 660 for outputting data to the user of the mobile device 600, such as prompts and information concerning the prepaid card outputted by the mobile application 612. The user input devices 650 include, but are not limited to, any number of devices allowing the mobile device 600 to receive data from the user, such as a keypad, keyboard, touch-screen, touchpad, microphone, mouse, joystick, stylus, other pointer device, button, soft key, and/or other input device(s). The user output devices 660 include, but are not limited to, a mobile display (e.g., a liquid crystal display (LCD), touch screen, or the like) and a speaker or other audio device(s). Both input and output devices are operatively coupled to the processor 620.

The mobile device 600 further includes a power source 640 for supplying energy needed to operate the mobile device. The power source 640 includes, but is not limited to, a battery (e.g., a lithium battery, a nickel-metal hydride battery, or the like) and/or a power adapter that can connect a power supply from a power outlet to the mobile device 600.

FIG. 7 depicts an example of a system 700 that facilitates processing of pay-and-load transactions and enables users to request such transactions via mobile devices, in accordance with embodiments of the present invention. The system 700 includes a processing system 710 comprising processor(s) 712, memory 714, and storage device(s) 716. Furthermore, the processing system 710 is coupled to input device(s) 720, such as a keyboard, a mouse, a touchscreen, a microphone, or the like, and output device(s) 725 such as a display, a speaker, and the like. The storage device 716 stores an operating system 717, application(s) 718, and data 719.

The application(s) 718 can include instructions, which when executed by the processing system 710, can cause the system 710 to perform/execute methods, operations, and/or processes described above with respect to FIGS. 3 to 5, 8, and 9. For example, the application(s) 718 can include instructions for (re)loading a prepaid card server-side, responsive to a request submitted via a mobile application installed at a mobile device, according to some embodiments of the present invention.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, CDs (compact discs), DVDs (digital versatile discs), or other media that are capable of storing code and/or data.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

The order of execution or performance of the operations in the embodiments illustrated and described herein is not essential, unless otherwise specified. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

What is claimed is:

1. A system for loading a prepaid card, the system hosted by a payment facilitator, the system comprising:
a reference data service platform storing at least fee and commission data; and
a service layer operable to communicate with the reference data service platform and further operable to communicate via a secure communication channel with one or more mobile devices, the service layer comprising:
a memory comprising a database for storing quotes for loading prepaid cards, the quotes generated by the service layer; and
at least one processor configured to perform a method for loading prepaid cards, the method comprising:
receiving, from a mobile device of the one or more mobile devices, through the secure communication channel, a pay-and-load request to load a prepaid card with a requested amount, the pay-and-load request comprising payment details;
retrieving a quote corresponding to the pay-and-load request from the database;
transmitting, toward a payment gateway, a payment authorisation request comprising the payment details and a payment amount indicated by the quote;
receiving an authorisation response from the payment gateway responsive to the payment authorisation request; and
transmitting, to a payment processing platform, a load request to load the prepaid card with the requested amount, if the authorisation response indicates a successful authorisation.

2. The system according to claim 1, wherein the method further comprises:
receiving a load response from the payment processing platform responsive to the load request; and
if the load response indicates that the prepaid card was successfully loaded, transmitting toward the mobile device a message indicating that the prepaid card was successfully loaded.

3. The system according to claim 2, wherein the method further comprises:
transmitting an error message toward the mobile device in response to the pay-and-load request, if the authorisation response indicates that an authorisation failed or the load response indicates that the prepaid card was not successfully loaded.

4. The system according to claim 1, wherein the method further comprises:
prior to transmitting the payment authorisation request toward the payment gateway, validating the quote to confirm that the quote is valid and/or the requested amount is within a pre-set amount limit; and
if validating the quote fails, transmitting an error message toward the mobile device in response to the pay-and-load request.

5. The system according to claim 1, wherein the method further comprises:
validating the payment details prior to transmitting the payment authorisation request toward the payment gateway; and
if validating the payment details fails, transmitting an error message toward the mobile device in response to the pay-and-load request.

6. The system according to claim 1, wherein the method further comprises:
receiving, from the mobile device, a request for the quote to load the prepaid card with the requested amount;
generating the quote comprising one or more fees associated with loading the prepaid card with the requested amount determined using data stored at the reference data service platform;
storing the quote in the database; and
transmitting the quote toward the mobile device.

7. The system according to claim 6, wherein generating the quote comprises:
retrieving, from the reference data service platform, the one or more fees in association with the quote; and
calculating the quote using the one or more fees,
wherein the one or more fees are dependent on at least one of a customer type associated with the prepaid card, a type of the prepaid card, or a customer service agreement, and comprise at least one of a service fee, a transaction fee, a commission fee associated with currency conversion, or an exchange rate.

8. The system according to claim 1, wherein the prepaid card is a multicurrency card supporting a plurality of currencies, the requested amount is in a requested currency of the plurality of currencies, and the service layer maintains current exchange rates for a plurality of currencies; and wherein determining the payment amount comprises:
calculating an amount in a payment currency based on the requested amount and a current exchange rate between the requested currency and the payment currency; and
determining the payment amount using at least the calculated amount, wherein the payment details identify an account in the payment currency.

9. The system according to claim 1, wherein the secure communication channel is established under a secure socket layer protocol.

10. The system according to claim 1, wherein the payment details identify one of a credit card or a debit card unregistered with the mobile device and comprise at least a payment card number, an expiry date, and a CVC2.

11. A computer-implemented method for loading a prepaid card via a mobile application installed at a mobile device, the method comprising:
receiving, via a user interface of the mobile application, a request from a user to load the prepaid card with a requested amount;
transmitting toward a service layer of a payment facilitator a request for a quote for loading the prepaid card with the requested amount;
receiving the quote from the service layer; and
in response to receiving an indication that the user of the mobile device has accepted the quote displayed by the mobile application,
prompting the user to enter payment details;
capturing the payment details; and
transmitting, via a secure communication channel toward the service layer of the payment facilitator, a request to load the prepaid card with the requested amount, the request to load comprising the payment details.

12. The method according claim 11, further comprising:
receiving from the service layer a response to the request to load the prepaid card with the requested amount; and
based on the response, indicating to the user through the user interface that the prepaid card has been successfully loaded or informing the user through the user interface about an error associated with loading the prepaid card.

13. The method according to claim 11, wherein the prepaid card is a multicurrency card supporting a plurality of currencies and the requested amount is in a requested currency of the plurality of currencies; wherein requesting the quote for loading the prepaid card comprises:
requesting the service layer to provide an amount in a payment currency corresponding to the requested amount in the requested currency;
receiving the payment amount in the payment currency; and
requesting the service layer to provide fees associated with loading the prepaid card;
wherein the quote comprises at least the fees and the amount in the payment currency and is based on at least one of a type of the user or a type of the prepaid card.

14. The method according claim 11,
wherein the method is performed without storing the payment details in association with the mobile application at the mobile device; and
wherein the payment details are of a payment card of the user and comprise at least a number, and expiry date, and a CVC2 of the payment card.

15. The method according to claim 11, further comprising:
enabling the user to perform through the mobile application at least one of:
determine a current balance of the prepaid card in one or more currencies associated with the prepaid card;
convert funds available on the prepaid card in one currency into funds in a different currency; or
deactivate the prepaid card.

16. The method according to claim 11, wherein the secure communication channel is established under a secure socket layer protocol.

17. A mobile device comprising:
at least one processor; and
a memory storing instructions which, when executed by the at least one processor, cause the mobile device to perform a method comprising:
receiving, via a user interface of the mobile device, a request from a user of the mobile device to load a prepaid card registered with the mobile device with a requested amount;
transmitting toward a service layer of a payment facilitator a request for a quote for loading the prepaid card with the requested amount;
receiving the quote from the service layer; and
in response to receiving an indication that the user has accepted the quote displayed on the mobile device through the user interface,
prompting the user to enter payment details;
capturing the payment details; and
transmitting, via a secure communication channel toward the service layer of the payment facilitator, a request to load the prepaid card with the requested amount, the request to load comprising the payment details.

18. The mobile device according to claim 17, further comprising a secure connection interface for establishing the secure communication channel between the mobile device and the service layer of the payment facilitator.

19. The mobile device according to claim 17, wherein the method further comprises:
receiving from the service layer a response to the request to load the prepaid card with the requested amount; and
based on the response, indicating to the user through the user interface that the prepaid card has been successfully loaded or informing the user through the user interface concerning an error associated with loading the prepaid card.

20. The mobile device according to claim 17 wherein the prepaid card is a multicurrency card supporting a plurality of currencies and the requested amount is in a requested currency of the plurality of currencies; wherein requesting the quote for loading the prepaid card comprises:
requesting the service layer to provide an amount in a payment currency corresponding to the requested amount in the requested currency;
receiving the payment amount in the payment currency; and
requesting the service layer to provide fees associated with loading the prepaid card; wherein the quote comprises at least the fees and the amount in the payment currency and is based on at least one of a type of the user or a type of the prepaid card.
